(19) United States
(12) Patent Application Publication
(10) Pub. No.: US 2008/0239359 A1
(43) Pub. Date: Oct. 2, 2008

(54) Image Forming Device

(75) Inventor: Masatoshi KADOTA, Takahama (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 12/057,626

(22) Filed: Mar. 28, 2008

(30) Foreign Application Priority Data
Mar. 30, 2007 (JP) 2007-091915

(51) Int. Cl. G06K 15/00

(52) U.S. Cl. 358/1.13; 358/1.16

(57) ABSTRACT

An image forming device is provided with a print data retrieving unit configured to retrieve print data from the external storage, and an image forming unit configured to form an image on a recording sheet based on the print data. If the modifying information representing modification of at least one of a command and data, which constitute the print data, is stored in the external storage, the print data is read out. A modifying unit modifies the at least one of the command and the data of the print data based on the modifying information. The image forming unit forms the image based on the modified print data.

### CROSS-REFERENCE TO RELATED APPLICATION

This application claims priority under 35 U.S.C. §119 from Japanese Patent Application No. 2007-091915 filed on Mar. 30, 2007. The entire subject matter of the application is incorporated herein by reference.

### BACKGROUND

1. Technical Field

The following description relates to an image forming device configured to form images on recording sheets. In particular, the following description relates to an image forming device capable of retrieving print data from a portable storage detachably connectable to the image forming device and forming images based on the print data retrieved from the portable storage.

2. Related Art

Conventionally, there is known an image forming device provided with a print data retrieving unit which retrieves print data from a portable storage, and an image forming unit which forms images on recording sheets based on the retrieved print data. With this type of image forming device, if the portable storage such as a USB (Universal Serial Bus) memory or a memory card, in which the print data has been stored in advance, is connected to the image forming device, the print data retrieving unit retrieves the print data stored therein and the image forming unit forms images on the recording sheets such as printing sheets.

When the print data is stored in such a portable storage using a printer driver installed in a personal computer, an image forming device to be used for forming the image based on the print data stored in the portable storage cannot be identified. Therefore, the print data is generated assuming that the printer to be used for printing the print data stored in the portable storage is, for example, similar to a printer locally connected to the personal computer. Accordingly, there could be a case where the print data stored in the portable storage may not conform to optional settings such as a tray setting of the image forming device to be actually used for printing the print data stored in the portable storage.

To deal with such a deficiency, there has been suggested an image forming device which is configured to automatically replace the print settings with practical settings if the print settings included in the print data cannot be handled by the image forming device to be actually used. An example of such a configuration of automatic replacement of the print data is disclosed in Japanese Patent Provisional Publication No. 2006-56176 (hereinafter, referred to as '176 publication).

### SUMMARY OF THE INVENTION

However, in such a configuration, the replaced print settings may not meet a user's demand. For example, when a maximum printable range of a printer engine is an A3 size with predetermined margin along each side, and print data including the print setting of A3 size recording sheet without margins, whether the print data is converted to the print setting of A3 with margins or to the print setting of B4 size sheet without margins should be determined by the user depending on the necessity. Further, once the print data has been replaced with modified print data, for example, to meet the image forming device having a relatively low function, it would be very difficult to print the same print data using an image forming device having a relatively high functionality.

In consideration of the above problem, the present invention is advantageous in that an improved image forming device is provided, with which images can be formed with appropriate print settings conforming with the functionality of the image forming device and printing options, without modifying the print data.

According to aspects of the invention, there is provided an image forming device to which an external storage is connectable. The image forming device is provided with a print data retrieving unit configured to retrieve print data from the external storage, an image forming unit configured to form an image on a recording sheet based on the print data retrieved by the print data retrieving unit, a modifying information retrieving unit configured to retrieve modifying information representing modification of at least one of a command and data, which constitute the print data, from the external storage if the modifying information is stored in the external storage, a modifying unit configured to modify the at least one of the command and the data of the print data based on the modifying information retrieved by the modifying information retrieving unit. If the at least one of the command and the data is modified by the modifying unit, the image forming unit forms the image on the recording sheet based on the modified print data.

According to another aspect of the invention, there is provided a method of printing, for an image forming device, based on print data stored in an external storage which is connectable to the image forming device. The method includes the steps of retrieving print data from the external storage, retrieving modifying information representing modification of at least one of a command and data, which constitute the print data, from the external storage if the modifying information is stored in the external storage, storing the print data retrieved by the step of retrieving if the modifying information is stored in the external storage, modifying the at least one of the command and the data of the print data based on the modifying information retrieved by the step of retrieving and forming an image on a recording sheet based on the print data if the at least one of the command and the data is modified.

According to a further aspect of the invention, there is provided a computer accessible recording medium storing a program to be executed by a computer of an image forming device which is configured to print images on recording sheets based on print data stored in an external storage which is connectable to the image forming device. The program causing the computer to execute the steps of retrieving print data from the external storage, retrieving modifying information representing modification of at least one of a command and data, which constitute the print data, from the external storage if the modifying information is stored in the external storage, storing the print data retrieved by the step of retrieving if the modifying information is stored in the external storage, modifying the at least one of the command and the data of the print data based on the modifying information retrieved by the step of retrieving and forming an image on a recording sheet based on the print data if the at least one of the command and the data is modified.

According to the above configurations, when the print data stored in the external storage is read out and images can be formed with appropriate print settings conforming with the functionality of the image forming device and printing options, without modifying the print data stored in the external storage.

### BRIEF DESCRIPTION OF THE ACCOMPANYING DRAWINGS

FIGS. 1A and 1B are perspective views of a personal computer and a printer of an image forming system, respectively.

FIGS. 2A and 2B are block diagrams showing control systems of the personal computer and the printer, respectively.

FIG. 3 schematically shows a data structure of print data.

FIG. 4A shows an example of print data, and FIG. 4B is exemplary formats of rules of print setting files.

FIG. 5 shows a flowchart illustrating a main process executed by the printer.

FIG. 6 shows a flowchart illustrating a file modifying process called in the main process.

FIG. 7 shows a flowchart illustrating a rule process called in the file modifying process.

FIG. 8 shows a flowchart illustrating a modification of the main process shown in FIG. 5.

FIG. 9 shows a flowchart illustrating another modification of the main process shown in FIG. 5.

FIG. 10 is a flowchart illustrating a modified rule process according to a third embodiment of the invention.

FIG. 11 is a flowchart illustrating a print setting file creating process which is executed.

### DETAILED DESCRIPTION

Hereinafter, an embodiment of the present invention will be described with reference to the accompanying drawings.

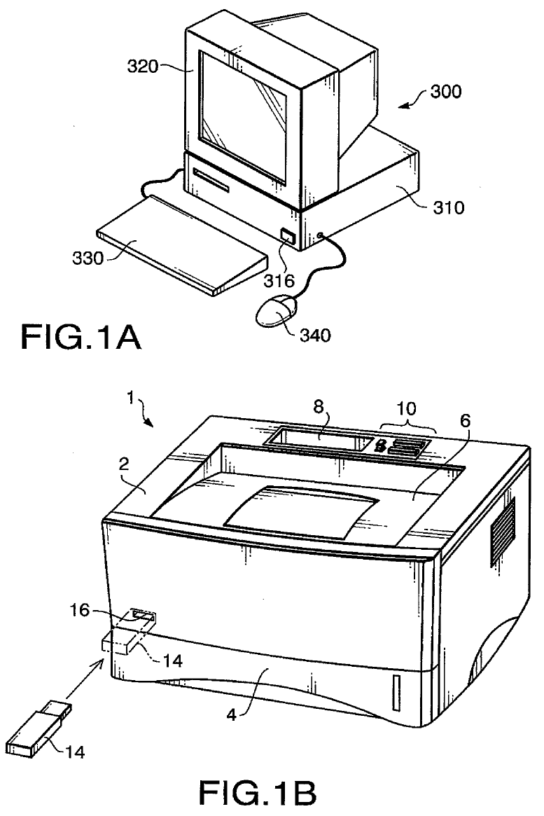

FIGS. 1A and 1B show a perspective view of an image forming system according to an embodiment of the invention. As shown in FIGS. 1A and 1B, the image forming system is provided with a printer 1 (which is an example of an image forming device), a personal computer (hereinafter, referred to as the “PC”) 300.

As shown in FIG. 1B, the printer 1 is provided with a main body 2. At a lower portion of the main body 2, a sheet feed cassette 4 for accommodating recording sheets is provided. The sheet feed cassette 4 can be drawn from the main body 2. On an upper surface of the main body 2, a tray portion 6 is defined. On the tray portion 6, recording sheets, on which images have been printed, are discharged and stacked. Further, on the upper surface of the main body 2, a display unit 8 provided with an LCD (Liquid Crystal Display) or the like for displaying various pieces of information, and an operation unit 10 provided with various keys for allowing a user to perform inputting operations are provided. Further, as shown in FIG. 1B, an insertion slot 16 to which a USB (Universal Serial Bus) memory 14 (which is an example of a portable storage) is detachably connected is formed.

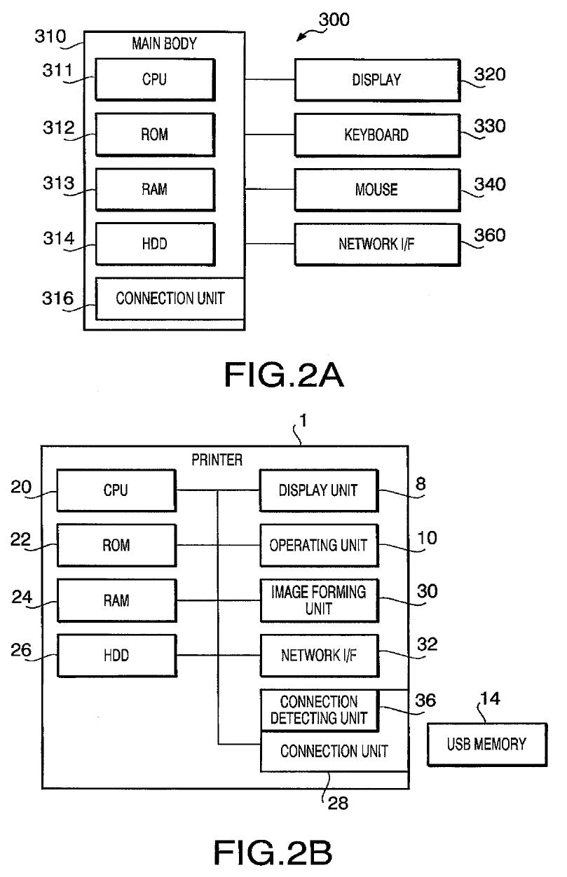

FIGS. 2A and 2B show a block diagram schematically illustrating a configuration of a control system of the print system. The printer 1 is provided with a CPU (Central Processing Unit) 20 for executing various programs, a ROM (Read Only Memory) 22 for storing the various programs, a RAM (Random Access Memory) 24 for temporarily storing various pieces of data such as resultant data of various processes executed by the CPU 20, an HDD (Hard Disk Drive) 26 for storing data, etc. The printer 1 is further includes a connection unit 28 to which the USB memory 14 is communicatably connected, the display unit 8, the operation unit 10, and an image forming unit 30 which is controlled based on the programs an executes a printing operation for printing images on the recording sheets. The printer I is further provided with a network I/F (Interface) 32 for connecting with a network such as a LAN (Local Area Network) or the Internet (not shown). The connection unit 28 is provided with a connection detector 36 for detecting connected/disconnected status of the USB memory 14. Specifically, the connection unit 28 is configured to monitor a signal level of a terminal (not shown) which is in a non-conductive status when the USB memory 14 is not connected to the connection unit 28, and in a conductive status when the USB memory 14 is connected to the connection unit 28.

The image forming unit 30 executes an image forming operation in accordance with a well-known electrophotographic imaging process. That is, a laser beam is ON/OFF modulated based on the image data and scanned within a predetermined angular range so that the surface of a photoreceptive drum, which is rotated, is scanned by the modulated laser beam (not shown) to form a electrostatic latent image thereon. The latent image is then developed as toner is applied thereto, thereby a toner image is formed. The toner image is transferred onto a recording sheet which is fed from the sheet feed cassette 4. The toner image transferred on the recording sheet is fixed on the recording sheet, which is discharged and stacked on the tray section 6. As described above, the image forming unit 30 is configured as a so-called page printer, which forms an page of the image (toner image) on one page of the recording sheet. It should be noted that the invention need not be limited to this configuration (i.e., the electrophotographic imaging device), but can be of other types such as an inkjet type serial printer (i.e., not a page printer).

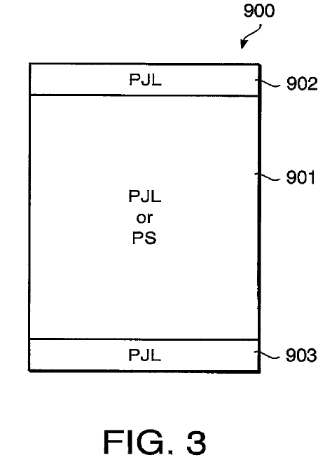

The printer 1 is configured to retrieve print data 900 (see FIG. 3) stored in the USB memory 14, store the print data 900 in the RAM 24, modify (if necessary) the print data 900 in the RAM 24 (which will be described later), and then develop the print data 900 in a frame memory of the RAM 24 to form image data. The image data developed in the frame memory of the RAM 24 is transferred to the image forming unit 30 as CMYK data (or K data in case of a grayscale image). Then the image forming unit 30 prints the image on the recording sheet. It should be noted that the printing operation may be either color printing or monochromatic printing.

The PC 300 is provided with a main body 310, which accommodates a CPU 311, a ROM 312, a RAM 313 and an HDD 314. Further, the PC 300 is provided with a connection unit 316 (see FIG. 1A) to which the USB memory 14 is detachably connected. To the main body 310, a well-known display 320, a keyboard 330, a mouse 340 are connected as shown in FIG. 1A. Further, the main body 310 is connected with a network I/F (interface) 360 for connecting to a network (not shown) such as the LAN or the Internet.

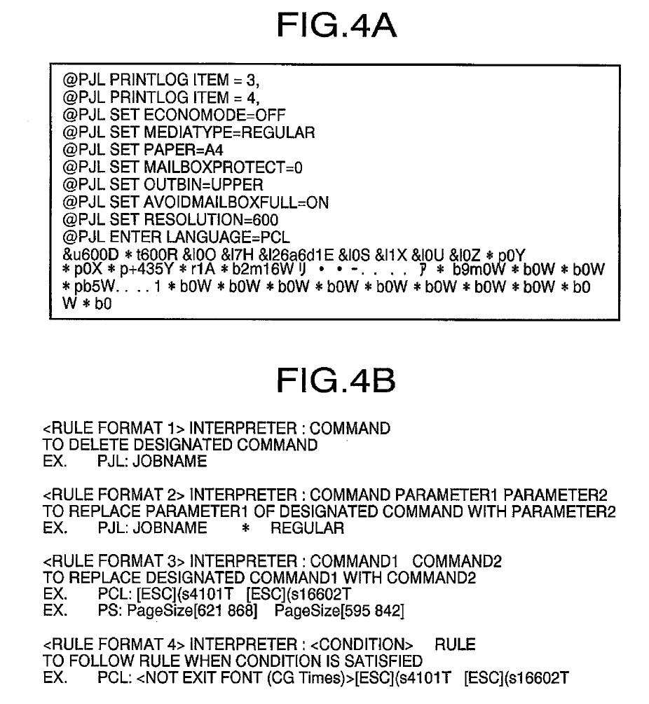

Next, a process executed in PC 300 will be described. FIG. 3 schematically shows a data structure of the print data 900 which is stored in the USB memory 14 using the printer driver. As shown in FIG. 3, most of the print data 900 is a PDL (Page Descriptive Language) section 901 which is described using widely used PDL such as PCL (Printer Control Language) or PS (PostScript). Before and after the PDL section 901, PJL (Printer Job Language) sections 902 and 903 are arranged. FIG. 4A shows an example of part of the print data 900 including the PJL 902 section and PDL 903 section. In this example, the PDL section 901 is described using the PCL. It should be noted that the PCL section is actually binary data, and since text codes are used substitutively for the binary data in order to depict the data structure, meaningless characters are shown at the PDL section 901 in FIG. 4A.

According to the embodiment, portions of the print data 900, which are defined based on language specification of PCL, PJL and PS, will be treated as commands, and the other portion of the print data 900 will be treated as data. For example, print data described by PCL and represents 100-byte raster data, <ESC>%b100W<100-byte raster data>, will be treated such that a portion “<ESC>%b100W” will be treated as a command, and the 100-byte raster data following the “command” will be treated as the data.

Regarding the PJL section of the print data 900, for example, “@PJL SET PAPER=A4” can be treated as a command if the parameter portion is presumable (e.g., A4, B4, LEGAL, LETTER, etc.), the entire portion including the parameter portion can be regarded as a command. However, if the PJL section reads, for example, @PJL JOB NAME=“name”, since the “name” portion is not presumable (i.e., variable), “@PJL JOB NAME=” is treated as a command, and the remaining portion (i.e., “name”) is treated as the data. It should be noted that the division of the command and data need not be limited to the manner described above, and may be appropriately changed depending on, for example, the specification and/or characteristics of the used language.

According to the embodiment, in addition to the print data 900, a setting file as shown in FIG. 4B is also stored in the USB memory 14. The setting file shown in FIG. 4B is a file describing rule formats, which will be explained in detail later. The setting file is created by the user using a text editor or a dedicated tool. If a USB memory 14 is used frequently with a printer manufactured by A company, the user may create the setting file conforming to the printer manufactured by A company in advance.

FIG. 4B shows the format of the rules set in the setting file.

<RULE FORMAT 1> shows a format of a rule for deleting a command. An item before colon (:) indicates an interpreter to be used, and an item after the colon (:) is a command to be deleted. An example indicated the section of Rule 1 represents deletion of a command (i.e., JOBNAME) for indicating a job name.

<RULE FORMAT 2> shows a format of a rule for replacing parameters. An item before colon (:) indicates an interpreter to be used, and items after the colon (:) indicate a command, a parameter to be replaced and a parameter to replace, in this order. If a symbol * is used as the parameter to be replaced, all the possible parameters corresponding to the command are subject to the replacement. An example indicated in the section of Rule 2 represents replacement of all the parameters of the media type with “REGULAR.”

<RULE FORMAT 3> shows a format of a rule for replacing commands. An item before colon (:) indicates an interpreter to be used, and items after the colon (:) indicate a command to be replaced and a command to replace, in this order. A first example indicated in the section of Rule 3 represents replacement of a command “[ESC](s4101T” with another command “[ESC](s16602T.” A second example represents replacement of a size of a page of “A4 and no margin” (“PageSize[621 8681”) with a page of “A4 and with margin” (“PageSize[595 8421”).

<RULE FORMAT 4> shows usage of a conditional expression by sandwiching the condition with symbols “<” and “>”. An example indicated in the section of Rule 4 represents replacement of a font “CG Times” with another font “Arial” if the printer 1 satisfies the condition indicated between “<” and “>” (i.e., the printer 1 does not have the “CG Times” font).

The replacement/deletion according to the rules are well-known operations and description regarding execution of the replacement/deletion operations will be omitted for brevity.

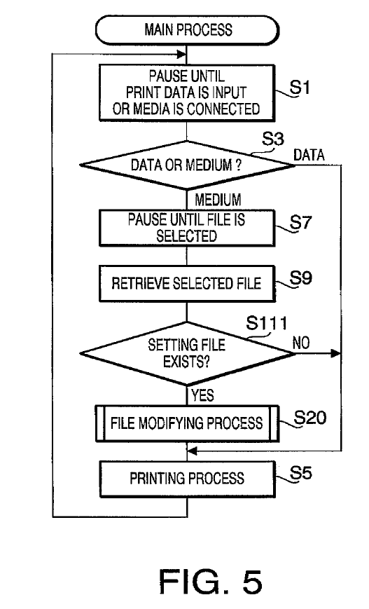

FIG. 5 is a flowchart illustrating a main process executed in the printer I. Specifically, the main process is executed by the CPU 20 of the printer 1 based on a program stored in the ROM 22.

When the main process starts, the process pauses in S1 until the print data 900 is received through the network interface 32 or the USB memory 14 is connected to the connection unit 28. If the print data 900 is received or the USB memory 14 is connected, the process proceeds to S3, and judges whether the print data 900 is received or the USB memory 14 is connected. If the print data 900 is received (S3: DATA), the process proceeds to S5 and controls the image forming unit 30 to execute a printing process based on the received print data 900. Then, the process returns to S1.

If the USB memory 14 is connected (S3: medium), the process proceeds to S7, and displays a file selection screen listing the files of the print data 900 stored in the USB memory 14 on the display unit 8. The process then pauses in S7 until the user selects one of the listed files. When the user selects a file, the process proceeds to S9, and the process retrieves the selected file of the print data 900 from the USB memory 14. Then, the process judges whether the print setting file as described above is stored in association with the print data 900. If such a print setting file is not stored in the USB memory 14 (S11: NO), the process executes the normal print process with respect to the selected file of the print data 900 (S5). If the print setting file is stored in the USB memory 14 (S11: YES), the process executes a file modifying process to modify the selected file of the print data 900 (S20) based on the print setting file, and then executes the print process in S5. It should be noted that, when modified, the print data 900 is once copied to the RAM 24, and the print data 900 stored in the RAM 24 is modified. Therefore, when the print data is modified 900, the print process (S5) is executed based on the print data 900 stored in the RAM 24.

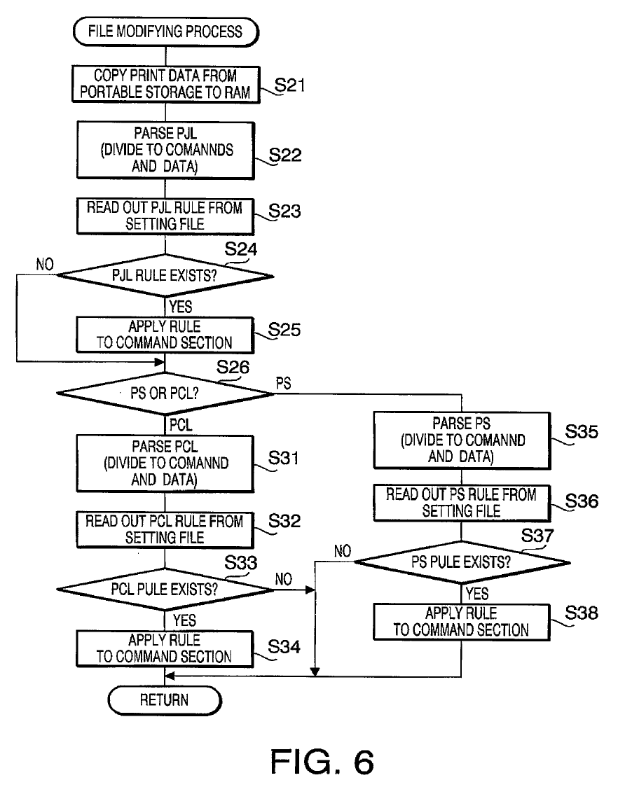

FIG. 6 is a flowchart illustrating the file modifying process which is called in S20 of the main process shown in FIG. 5. It should be noted that the file modifying process is executed when the file of the print data 900 and associated print setting file are stored in the USB memory 14. As mentioned above, according to the invention, in such a case, the file of the print data 900 and the print setting file are copied to the RAM 24 (S21), and the copied files are modified. Since the copied files are modified, the original files stored in the USB memory 14 are remained as they are.

As shown in FIG. 6, the process parses the PJL sections 902 and 903 (S22) of the file of the print data 900 stored (copied) on the RAM 24 to divide the file into command sections and data sections. Then, in S23, the process attempts to read out the rules regarding the PJL from the print setting file. In S24, the process judges whether there exists a rule regarding the PJL in the print setting file. If the rules regarding the PJL is not contained (S24: NO), the process proceeds to S26. If the rules regarding the PJL is contained (S24: YES), the process executes a rule applying process with respect to the command sections of the PJL (S25).

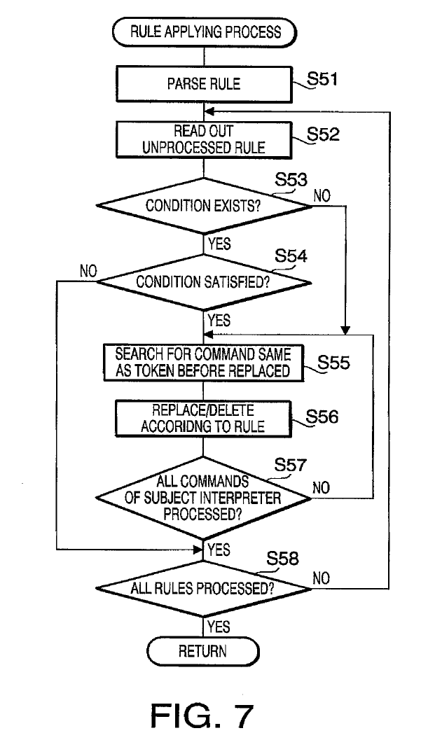

FIG. 7 is a flowchart illustrating the rule applying process executed in S25 of the file modifying process shown in FIG. 6.

In S51, the process parses the rules by analyzing the print setting file stored in the RAM 24. In S52, the process reads one of the unprocessed rules, and judges whether the rule includes a conditional expression by sandwiching the condition with symbols “<” and “>” (S53). If the rule includes a conditional expression (S53: YES), the process judges whether the condition is satisfied (S54). If the condition is satisfied (S54: YES), the process proceeds to S55. If the rule does not include a conditional expression (S53: NO), the process proceeds to S55. In S55, the process reads the print data 900 on a command or a piece of data basis, searches for a command which is the same as a token, defined by the rule, before replacement. In S56, the searched command is deleted or replaced in accordance with the rule.

In S57, the process judges whether the above-described searching and replacing/deleting operation has been applied to all the commands of the subjected interpreter (in this example, all the commands in the sections 902 and 903 of the print data 900 stored in the RAM 24). If the searching or replacing/deleting operation has not been finished (S57: NO), the process returns to S55. If the searching and replacing/deleting operations have been finished (S57: YES), the process proceeds to S58 and then the process judges whether the above-described process has been finished with respect to all the rules contained in the print setting file. If the process has not been finished (S58: NO), the process returns to S52 where the next unprocessed rule is read out and the above-described steps are repeated. If the rule contains a conditional description (S53: YES), and the condition is not satisfied (S54: NO), no process is executed for the condition and the process proceeds to S58. When the above-described process is executed with respect to all the rules (S58 YES), the process returns to S26 of FIG. 6.

Back to FIG. 6, the process judges whether the PDL employed in the printer 1 is PS or PCL (S26). If the PCL is employed (S26: PCL), the process proceeds to S31, where the PDL portion described in PCL is parsed and divided into the commands and data. Then, in S32, the process attempts to read out a rule regarding the PCL from the print setting file. In S33, the process judges whether the print setting file contains rules regarding the PCL. If there is not a rule regarding the PCL (S33: NO), the process returns to S5. If there is a rule regarding the PCL (S33: YES), the process executes the rule process with respect to the command section of the PCL (S34), and returns to S5 (see FIG. 5).

If the PS is employed as the PDL in the printer 1 (S26: PS), the process proceeds to S35, where the PDL section 901 described in PS is parsed and is divided into the command and the data. In S36, the process attempts to read out the rules with respect to the PS in the print setting file (S37). If there is not a rule regarding the PS (S37: NO), the process returns to S5 (see FIG. 5). If there is a rule (S37: YES), the process applies the rule to the command section of the PS (S38), and returns to S5 (see FIG. 5). The processing in each of S34 and S38 are the same as the processing in S25 (FIG. 7).

As described above, according to the embodiment, if the print setting file corresponding to an option to the printer 1 is stored in the USB memory 14 together with the print data 900, printing can be executed with modifying the command of the print data 900 arbitrarily and automatically. The print setting file may be stored in the USB memory 14 when it is necessary for the user. Further, even though the print setting file is stored, the print data 900 stored in the USB memory 14 will not be modified since the print data 900 is copied to the RAM 24, and the copied data is modified. Therefore, according to the embodiment, printing can be executed with appropriate setting which corresponds to the performance of the printer 1 and/or the print options. If a condition allowing the replacement or deletion described above is set, the command of the print data can be modified further appropriately.

Further, according to the embodiment, if both the rules for PS and rules for PCL are stored in the print setting file, only the rules corresponding to the PDL employed in the printer are processed (S26-S38). Thus, the rules which will not be processed by the printer 1 are skipped, which may accelerate the printing process.

In the above-described exemplary embodiment, by parsing the print data 900, the commands and the data are separated, and thereafter the rule applying process is executed (S22, S31 and S35). Thus, even if there exists a character string which coincidentally match a command subject to processed by the rule process in the data section of print data 900, the character string will not be subject to the rule applying process, and therefore, the replacement or deletion of the character string will be prevented.

It should be appreciated that the invention need not be limited to the configuration of the above-described exemplary embodiment, and can be modified in various ways without departing from the gist of the invention. For example, when a plurality of print setting files are stored in the USB memory 14, a file modifying process is executed using an appropriate one of the print setting files.

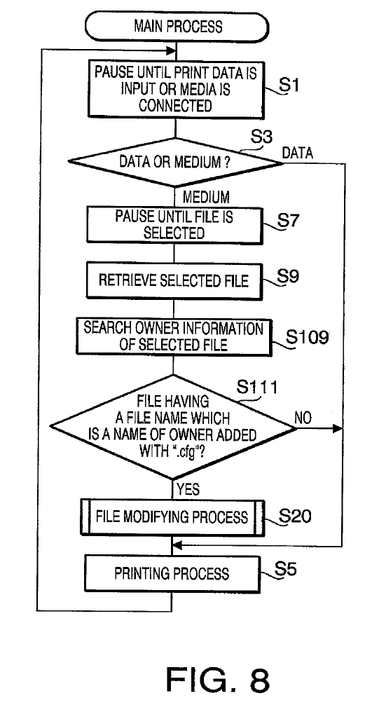

FIG. 8 is a flowchart illustrating a main process for selecting one of a plurality of print setting files corresponding to an owner name of the print data 900. The main process shown in FIG. 8 is different from the flowchart sown in FIG. 5 such that S11 of FIG. 5 is replaced with S109 and S111. In the following description, only the steps S109 and S111 will be described for brevity.

When a file of the print data 900 selected in S9 is retrieved, according to the file system, the process researches the owner information of the selected file in S109. The owner information is recorded as a part of the print data, or recorded as a part of file information in the file system. Then, in S111, the process judges whether a file, which has a name similar to the name of the owner and having an extension “.cfg” is stored in the USB memory 14.

If the file having the name of the owner and having the extension “.cfg” does not exit (S11: NO), the process skips S20 and proceeds to S5. If the file exists (S11: YES), the process sets the file as the print setting file and proceeds to S20. That is, with respect to the file of the print data 900 retrieved in S9, the modifying process shown in FIG. 6 is applied using the setting file which has the name of the owner and the extension of “.cfg.”

According to the above modification, if the name of the owner is unknown or there is no owner name, the file modifying process is executed using a default print setting file (S20). With this configuration, an appropriate print setting file is selected in accordance with the name of the owner of the print data 900. Thus, modification of the commands meeting the demand of the user can be executed.

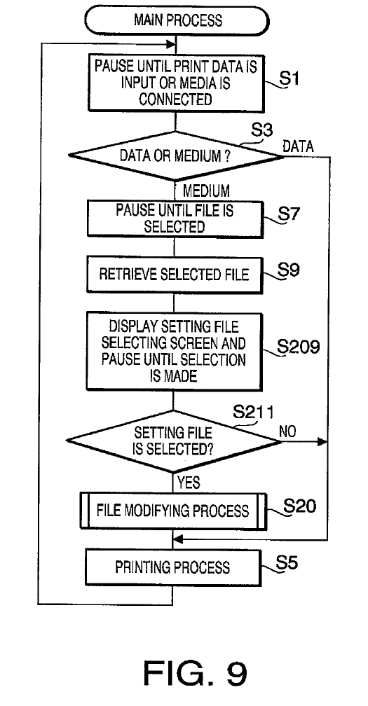

Alternatively, the print setting file may be selected by the user. FIG. 9 shows a flowchart of a main process illustrating a case where the print setting file is selected in accordance with the operation of the user. The main process shown in FIG. 9 is similar to that shown in FIG. 5 except that S11 is replaced with S209 and S211.

In this case, if the file of the print data 900 selected in S9 is retrieved, a print setting file selection window is displayed in the display unit 8, and the process is paused until the user select or cancel a file from the displayed list. When no files are selected, i.e., when the selection is cancelled (S211: NO), the process proceeds to the print process (S5). If a print setting file is selected (S211: YES), the process executes the file modifying process in S20 based on the print setting file as selected. With this configuration, according to the operation of the user who executes the printing, modification of the command meeting the demand of the user can be performed.

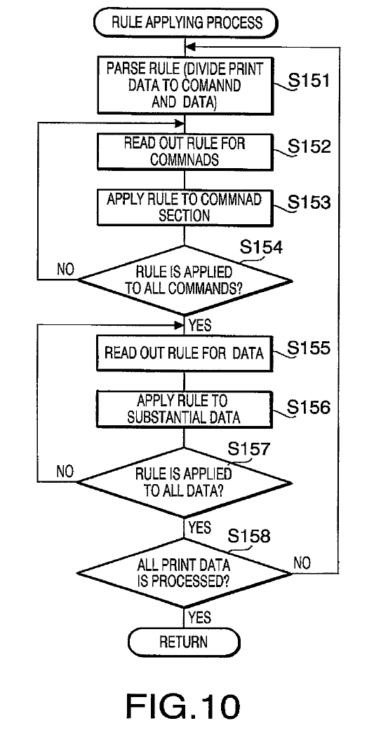

Further, in the above-described embodiment and modifications, replacement/deletion of the commands are executed. The invention need not be limited to such a configuration and replacement/deletion may be performed with respect the data. Such a modification will be described with reference to FIG. 10.

FIG. 10 shows a flowchart of a rule applying process according to a modification of the invention.

As shown in FIG. 10, the process parses the print data 900 (S 151) stored in the RAM 24 copied from the USB memory 14, and divides the print data 900 into command sections and data section. Then, in S152, the process reads out one rule for the command from the print setting file stored in the RAM 24 copied from the USB memory 14, and applies the rule to the command section. Here, to “apply” means to execute steps S53-S57 of FIG. 7. In S 154, the process judges whether the application of the rule is applied to all the commands of the print setting file. If there remains a rule, for the commands in the print setting file, not yet applied to the command (S154: NO), the process proceeds to S152, where the next rule for the command is read out the process above (i.e., S53-S57) is repeated. When all the rules are processed (i.e., S53-S57 are executed) (S154: YES), the process proceeds to S155.

In S155, the process reads out one rule for the data from the print setting file, and applies the rule to the data section (i.e., the data), which is also stored in the RAM 24 copied from the USB memory 14, in S156. Similar to the above, the “application” of the rule is to execute steps S53-S57 of FIG. 7. In S157, the process judges whether the steps S53-S57 are executed for all the rules for the data of the print setting file. If there remains a rule for the data of the print setting file, for which the steps S53-S57 have not yet been executed (S1 57: NO), the process proceeds to S155. Then, the next rule is read out and the process similar to the above is repeated. When the above process (i.e., S53-S57) is executed for all the rules for the data (S157: YES), the process proceeds to S1 58.

In S158, the process judges whether the above process (i.e., S53-S57) has been executed for the all the print data 900 stored the USB memory 14. If the process has not yet been finished (S158: NO), the process returns to S151 and repeats the similar process. When all the print data 900 is processed (S158: YES), the process returns to the file modifying process S5 shown in FIG. 5.

As described above, if the rule is set for the data, the rule may be used as indicated below. For example, if a rule: “PCL: DATA %%%NAME%%% Suzuki” is set, and the print data 900 is created such that portions at which a name of a person may be replaced has a character string of “%%%NAME%%%” which is to be replaced. By creating the data file 900, it is possible to replace the above character string with a name when the printing is executed. It should be noted that the character string “%%%” is used since such a character string hardly appear in a normal text and thus ensures that the replacement can be executed only at the intended portions. Therefore, different character string (“@@@” for example) may be used instead of “%/%%.” Accordingly, for example, if a rule: “PCL: @@@DATA@@@ Original Copy” is set, a character string “Original” can be replaced with “Copy” throughout a text.

Further, according to the above process, the rule process for the commands and the rule process for the data are executed independently. Therefore, confusion between the change made to the commands and change made to the data can be suppressed, and enables the printing operation with an appropriate setting.

As the image forming device, various image forming devices such as a printer, an MFP (Multi-Functional Peripheral) provided with a scanner and a modem and the like may be used. Further, as the portable storage, various media such as a memory card, a portable hard disk, a CD-R and a CD-RW may be used as well as the USB memory.

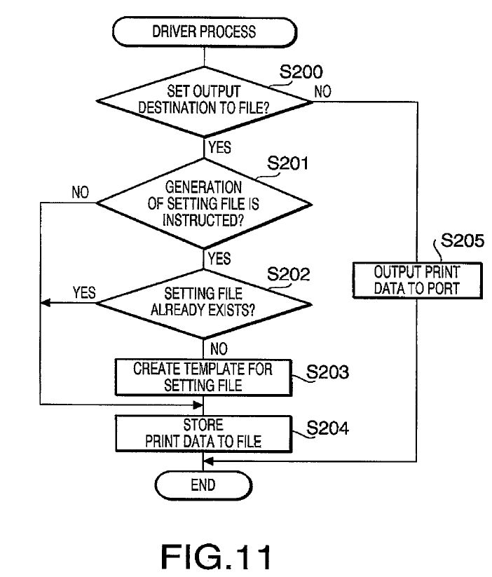

It should be noted that the print setting file is not limited to one created by the text editor or dedicated tools. For example, as described below with reference to FIG. 11, the printer driver may be configured to create a template of the print setting file.

FIG. 11 shows a flowchart illustrating a file creating process. When the printer driver is instructed to execute the printing operation, the process judges whether output data is stored as a file or transmitted to the printer. If the data is to be stored as a file (S200: YES), the process judges whether creation of a file is instructed on the setting dialogue of the printer driver. If the creation of a file is instructed (S201: YES), the process judges whether the print setting file is already stored in a destiration medium (e.g., the USB memory 14) in S202. If the print setting file is not stored in the destination medium (S202: NO), the process creates the template of the print setting file in S203. The template is a file containing conversion rules to be used the command system of the printer driver following comment marks. Thereafter, the process stores the print data as a file in the destination medium, and the process is terminated.

If the creation of the print setting file is not instructed in the setting dialogue of the printer driver (S201: NO), the process does not create the print setting file and proceeds to S204 (store print data to file). If the print setting file is already stored (S202: YES), the process does not create the print setting file and proceeds to S204 so as to prevent the print setting file that has been stored by the user from being deleted by overwriting. When the file is not to be output (S200: NO), the process does not create the print setting file, outputs the print data and then the process is terminated.

In template of the print setting file created in the above process, comment marks are added for each items. The comment marks make the each setting items disabled. Therefore, the contents of the print setting file (template) are disregarded unless the user removes the comment marks. By removing the comment mark, the corresponding setting is enabled. That is, the user may remove such a comment mark to make the necessary setting item effective. By removing the comment marks, the user can make setting items effective, modify the setting items, or add new setting items, by referring to existing items with comment marks in the template. With this configuration, even a user who does not have sufficient knowledge of print commands can creates the print setting file relatively easily.

What is claimed is:

1. An image forming device to which an external storage is connectable, comprising:
a print data retrieving unit configured to retrieve print data from the external storage;
an image forming unit configured to form an image on a recording sheet based on the print data retrieved by the print data retrieving unit;
a modifying information retrieving unit configured to retrieve modifying information representing modification of the print data, from the external storage if the modifying information is stored in the external storage;
a modifying unit configured to modify the print data based on the modifying information retrieved by the modifying information retrieving unit,
wherein, if the print data is modified by the modifying unit, the image forming unit forms the image on the recording sheet based on the modified print data.

2. The image forming device according to claim 1,
wherein, if the modifying information includes pieces of modifying information respectively for languages describing the print data, the modifying information retrieving unit retrieves only a piece of modifying information corresponding to the language the image forming device is capable of processing, and
the modifying unit modifies the print data based only on the piece of modifying information retrieved by the modifying information retrieving unit.

3. The image forming device according to claim 2,
wherein the print data includes a command and data,
wherein the image forming device further comprises a dividing unit configured to divide the print data into command and data, and
wherein the modifying unit applies modification to the command and the data, separately.

4. The image forming device according to claim 2,
wherein the print data includes a command and data,
wherein the image forming device further comprises a dividing unit configured to divide the print data into command and data, and
wherein the modifying unit applies modification to at least one of the command and the data.

5. The image forming device according to claim 1,
wherein a plurality of pieces of the modifying information are stored in the external storage,
wherein the image forming device further comprises a modifying information selecting unit configured to select one of the plurality of pieces of the modifying information, and
wherein the modifying unit modifies print data based on the one of the plurality of pieces of the modifying information selected by the modifying information selecting unit.

6. The image forming device according to claim 5,
wherein the modifying information selecting unit selects the modifying information based on management information stored in association with the print data in the external storage.

7. The image forming device according to claim 5,
wherein the modifying information selecting unit selects the modifying information in accordance with an operation by a user of the image forming device.

8. The image forming device according to claim 1,
wherein the modifying information includes a condition to be satisfied to allow modification of the print data, and
wherein the modifying unit executes the modification only when the condition is satisfied.

9. A method of printing, for an image forming device, based on print data stored in an external storage which is connectable to the image forming device, comprising the steps of:
retrieving print data from the external storage;
retrieving modifying information representing modification of the print data, from the external storage if the modifying information is stored in the external storage;
storing the print data retrieved by the step of retrieving if the modifying information is stored in the external storage;
modifying the print data based on the modifying information retrieved by the step of retrieving; and
forming an image on a recording sheet based on the print data if the print data is modified.

10. The method according to claim 9,
wherein, if the modifying information includes pieces of modifying information respectively for languages describing the print data, the step of retrieving retrieves only a piece of modifying information corresponding to the language the image forming device is capable of processing, and
wherein the step of modifying modifies the print data based only on the piece of modifying information retrieved by the step of retrieving.

11. The method according to claim 9,
further comprising the step of dividing the print data, which includes command and data, into the command and the data,
wherein the step of modifying applies modification to the command and the substantial data, separately.

12. The method according to claim 9,
wherein a plurality of pieces of the modifying information are stored in the external storage,
wherein the method further includes the step of selecting one of the plurality of pieces of the modifying information, and
wherein the step of modifying modifies the print data based on the one of the plurality of pieces of the modifying information selected by step of selecting.

13. The method according to claim 12,
wherein the method of selecting selects the modifying information based on management information stored in association with the print data in the external storage.

14. The method according to claim 12,
wherein the step of selecting selects the modifying information in accordance with an operation by a user of the image forming device.

15. The method according to claim 9,
wherein the modifying information includes a condition to be satisfied to allow modification of the print data, and
wherein the step of modifying executes the modification only when the condition is satisfied.

16. A computer accessible recording medium storing a program to be executed by a computer of an image forming device which is configured to print images on recording sheets based on print data stored in an external storage which is connectable to the image forming device, the program causing the computer to execute the steps of:
retrieving print data from the external storage;
retrieving modifying information representing modification of the print data, from the external storage if the modifying information is stored in the external storage;
storing the print data retrieved by the step of retrieving if the modifying information is stored in the external storage;
modifying the print data based on the modifying information retrieved by the step of retrieving; and
forming an image on a recording sheet based on the print data if the print data is modified.

17. The recording medium according to claim 16,
wherein, if the modifying information includes pieces of modifying information respectively for languages describing the print data, the step of retrieving retrieves only a piece of modifying information corresponding to the language the image forming device is capable of processing, and
wherein the step of modifying modifies the print data based only on the piece of modifying information retrieved by the step of retrieving.

18. The recording medium according to claim 16,
further comprising the step of dividing the print data, which includes command and data, into the command and the data,
wherein the step of modifying applies modification to the command and the data, separately.

19. The recording medium according to claim 16,
wherein a plurality of pieces of the modifying information are stored in the external storage,
wherein the method further includes the step of selecting one of the plurality of pieces of the modifying information, and
wherein the step of modifying modifies the print data based on the one of the plurality of pieces of the modifying information selected by step of selecting.

20. The recording medium according to claim 16,
wherein the modifying information includes a condition to be satisfied to allow modification of the print data, and
wherein the step of modifying executes the modification only when the condition is satisfied.
